(19) United States
(12) Patent Application Publication
(10) Pub. No.: US 2022/0251348 A1
(43) Pub. Date: Aug. 11, 2022

(54) Thermoplastic Resin Composition, and Molded Article Therefrom

(71) Applicant: LOTTE CHEMICAL CORPORATION, Seoul (KR)

(72) Inventors: Sung Oh EIM, Uiwang-si (KR); Dong Hui CHU, Uiwang-si (KR)

(21) Appl. No.: 17/626,874

(22) PCT Filed: Sep. 9, 2020
(86) PCT No.: PCT/KR2020/012162

§ 371 Date: Jan. 13, 2022

(30) Foreign Application Priority Data
Oct. 30, 2019 (KR) 10-2019-0136220

(51) Int. Cl. C08L 9/06; C08L 23/08; C08L 23/16

(52) U.S. Cl. CPC C08L 9/06; C08L 2201/08; C08L 23/16; C08L 23/0815

(57) ABSTRACT

A thermoplastic resin composition according to the present invention is characterized by comprising: about 100 parts by weight of a rubber-modified aromatic vinyl-based copolymer resin; about 6 to about 35 parts by weight of a propylene-ethylene random copolymer resin; about 3 to about 10 parts by weight of a styrene-butadiene rubbery polymer; and about 1 to about 10 parts by weight of an ethylene-α-olefin rubber polymer. The thermoplastic resin composition has excellent impact resistance, hardness, heat resistance, chemical resistance, and moldability.

### TECHNICAL FIELD

The present invention relates to a thermoplastic resin composition and a molded article produced therefrom. More particularly, the present invention relates to a thermoplastic resin composition that exhibits good properties in terms of impact resistance, rigidity, heat resistance, chemical resistance, moldability, and the like, and a molded article produced therefrom.

### BACKGROUND ART

A rubber-modified aromatic vinyl copolymer resin, such as an acrylonitrile-butadiene-styrene copolymer resin (ABS resin) and the like, has good properties in terms of impact resistance, rigidity, heat resistance, chemical resistance, moldability, and chemical resistance with respect to Freon (CFC-11) used as a foaming agent for hard urethane foam, and is applied to resins for refrigerators and the like.

However, since it was found that conventional foaming compounds including Freon destroy the ozone layer, the conventional foaming compounds have been replaced by eco-friendly foaming agents, such as hydrofluoroolefin (HFO) foaming agents, which have very low global warming potential (GWP) and ozone depleting potential (ODP) values and high foaming efficiency. Since such eco-friendly foaming agents exhibit stronger chemical erosion than the conventional foaming compounds, the eco-friendly foaming agents are required to have a higher level of chemical resistance than resins for refrigerators used together therewith.

Due to advantages such as good chemical resistance, low specific gravity, and high price competitiveness, polyolefin resins including polypropylene resins can be used as the resins for refrigerators to which the eco-friendly foaming agents are applied. However, the polyolefin resins have problems such as post-shrinkage due to low heat resistance and hardness upon urethane expansion, no contact with expanded urethane, and the like.

Although it is suggested to apply a mixture of a polyolefin resin and a rubber-modified aromatic vinyl copolymer resin, there is a problem of deterioration in properties upon mixing due to lack of compatibility between the polyolefin resin and the rubber-modified aromatic vinyl copolymer resin.

Therefore, there is a need for development of a thermoplastic resin composition that exhibits good properties in terms of impact resistance, rigidity, heat resistance, chemical resistance, moldability, and the like without suffering from such problems.

The background technique of the present invention is disclosed in Korean Patent Laid-open Publication No. 10-2009-0073453 and the like.

### DISCLOSURE

### Technical Problem

It is one object of the present invention to provide a thermoplastic resin composition having good properties in terms of impact resistance, rigidity, heat resistance, chemical resistance, moldability, and the like.

It is another object of the present invention to provide a molded article produced from the thermoplastic resin composition.

The above and other objects of the present invention can be achieved by the present invention described below.

### Technical Solution

1. One aspect of the present invention relates to a thermoplastic resin composition. The thermoplastic resin composition includes: about 100 parts by weight of a rubber-modified aromatic vinyl copolymer resin; about 6 parts by weight to about 35 parts by weight of a propylene-ethylene random copolymer resin; about 3 parts by weight to about 10 parts by weight of a styrene-butadiene rubber polymer; and about 1 part by weight to about 10 parts by weight of an ethylene-α-olefin rubber polymer.

2. In embodiment 1, the rubber-modified aromatic vinyl copolymer resin may include a rubber-modified vinyl graft copolymer and an aromatic vinyl copolymer resin.

3. In embodiment 1 or 2, the rubber-modified vinyl graft copolymer may be prepared through graft polymerization of a monomer mixture including an aromatic vinyl monomer and a vinyl cyanide monomer to a rubber polymer.

4. In embodiments 1 to 3, the propylene-ethylene random copolymer resin may be a polymer of a monomer mixture including about 90 wt % to about 99 wt % of propylene and about 1 wt % to about 10 wt % of ethylene.

5. In embodiments 1 to 4, the propylene-ethylene random copolymer resin may have a melt-flow index (MI) of about 1 g/10 min to about 10 g/10 min, as measured under conditions of 230° C. and 2.16 kgf in accordance with ASTM D1238.

6. In embodiments 1 to 5, the styrene-butadiene rubber polymer may be a polymer of a monomer mixture including about 25 wt % to about 45 wt % of styrene and about 55 wt % to about 75 wt % of butadiene.

7. In embodiments 1 to 6, the ethylene-α-olefin rubber polymer may be a polymer of a monomer mixture including about 25 wt % to about 55 wt % of ethylene and about 45 wt % to about 75 wt % of α-olefin.

8. In embodiments 1 to 7, the propylene-ethylene random copolymer resin and the styrene-butadiene rubber polymer may be present in a weight ratio of about 2:1 to about 4:1.

9. In embodiments 1 to 8, the styrene-butadiene rubber polymer and the ethylene-α-olefin rubber polymer may be present in a weight ratio of about 1:1 to about 3:1.

10. In embodiments 1 to 9, the thermoplastic resin composition may have a notched Izod impact strength of about 13 kgf·cm/cm to about 25 kgf·cm/cm, as measured on a ¼″ thick specimen in accordance with ASTM D256.

11. In embodiments 1 to 10, the thermoplastic resin composition may have a tensile strength of about 250 kgf/cm² to about 400 kgf/cm², as measured on a 3.2 mm thick specimen at 5 mm/min in accordance with ASTM D638.

12. In embodiments 1 to 11, the thermoplastic resin composition may have a Vicat softening temperature of about 80° C. to about 95° C., as measured under a load of 5 kgf at 50° C./hr in accordance with ISO R306.

13. In embodiments 1 to 12, the thermoplastic resin composition may have a crack generation strain (ε) of about 1% to about 1.2%, as calculated on a specimen having a size of 200 mm×50 mm×2 mm according to Equation 1 after the specimen is mounted on a ¼ elliptical jig (major axis length: 120 mm, minor axis length: 34 mm), entirely coated with 10 ml of olive oil, and left for 24 hours:

$$ε = \frac{{b}^{2}}{2 \times {a}^{2}} \times {\{ 1 - \frac{( {a}^{2} - {b}^{2} )}{{a}^{4}} \times {x}^{2} \}}^{- 3 / 2} \times t \times 100 \qquad [ Equation 1 ]$$

where ε denotes crack generation strain, a denotes the major axis length (mm) of the elliptical jig, b denotes the minor axis length (mm) of the elliptical jig, t denotes the thickness (mm) of the specimen, and x denotes a distance from a vertical intersection point between a point at which cracking occurs and the major axis of the elliptical jig to a central point of the elliptical jig.

14. In embodiments 1 to 13, the thermoplastic resin composition may have a high temperature tensile strength of about 10 kgf/cm² to about 20 kgf/cm², as measured on a specimen having a size of 65 mm×3.2 mm (length×thickness) at 150 mm/min in accordance with ASTM D638 after aging the specimen in a chamber at 130° C. for 5 min.

15. Another aspect of the present invention relates to a molded article. The molded article is produced from the thermoplastic resin composition according to any one of Embodiments 1 to 14.

### Advantageous Effects

The present invention provides a thermoplastic resin composition having good properties in terms of impact resistance, rigidity, heat resistance, chemical resistance, moldability, and the like, and a molded article produced therefrom.

### BEST MODE

Hereinafter, embodiments of the present invention will be described in detail.

A thermoplastic resin composition according to the present invention includes: (A) a rubber-modified aromatic vinyl copolymer resin; (B) a propylene-ethylene random copolymer resin; (C) a styrene-butadiene rubber polymer; and (D) an ethylene-α-olefin rubber polymer.

As used herein to represent a specific numerical range, the expression “a to b” means “≥a and ≤b”.

(A) Rubber-Modified Aromatic Vinyl Copolymer Resin

A rubber-modified aromatic vinyl copolymer resin according to one embodiment of the present invention may include (A1) a rubber-modified vinyl graft copolymer and (A2) an aromatic vinyl copolymer resin.

(A1) Rubber-Modified Vinyl Graft Copolymer

The rubber-modified vinyl graft copolymer according to the embodiment of the present invention may be obtained through graft polymerization of a monomer mixture including an aromatic vinyl monomer and a vinyl cyanide monomer to a rubber polymer. For example, the rubber-modified vinyl graft copolymer may be obtained through graft polymerization of the monomer mixture including the aromatic vinyl monomer and the vinyl cyanide monomer to the rubber polymer and, optionally, the monomer mixture may further include a monomer for imparting processability and heat resistance. Here, polymerization may be performed by any suitable polymerization method known in the art, such as emulsion polymerization, suspension polymerization, and the like. Further, the rubber-modified vinyl graft copolymer may have a core (rubber polymer)-shell (copolymer of the monomer mixture) structure, without being limited thereto.

In some embodiments, the rubber polymer may include diene rubbers, such as polybutadiene and poly(acrylonitrile-butadiene), saturated rubbers obtained by adding hydrogen to the diene rubbers, isoprene rubbers, C₂ to C₁₀ alkyl (meth)acrylate rubbers, copolymers of C₂ to C₁₀ alkyl (meth)acrylate rubbers and styrene, ethylene-propylene-diene terpolymer (EPDM), and the like. These may be used alone or as a mixture thereof. For example, the rubber polymer may include diene rubbers, (meth)acrylate rubbers, specifically butadiene rubbers, butyl acrylate rubbers, and the like.

In some embodiments, the rubber polymer (rubber particles) may have an average (z-average) particle diameter of about 0.05 μm to about 6 μm, for example, about 0.15 μm to about 4 μm, specifically about 0.25 μm to about 3.5 μm. Within this range, the thermoplastic resin composition can have good impact resistance and appearance characteristics. Here, the average (Z-average) particle diameter of the rubber polymer (rubber particles) may be measured by a light scattering method in a latex state. Specifically, a rubber polymer latex is filtered through a mesh to remove coagulum generated during polymerization of the rubber polymer. Then, a mixed solution of 0.5 g of the latex and 30 ml of distilled water is placed in a 1,000 ml flask, which in turn is filled with distilled water to prepare a specimen. Then, 10 ml of the specimen is transferred to a quartz cell, followed by measurement of the average particle diameter of the rubber polymer using a light scattering particle analyzer (Malvern Co., Ltd., Nano-zs).

In some embodiments, the rubber polymer may be present in an amount of about 20 wt % to about 80 wt %, for example, about 25 wt % to about 70 wt %, based on 100 wt % of the rubber-modified vinyl graft copolymer, and the monomer mixture (including the aromatic vinyl monomer and the vinyl cyanide monomer) may be present in an amount of about 30 wt % to about 80 wt %, for example, about 40 wt % to about 75 wt %, based on 100 wt % of the rubber-modified vinyl graft copolymer. Within this range, the thermoplastic resin composition can have good properties in terms of impact resistance, appearance characteristics, and the like.

In some embodiments, the aromatic vinyl monomer may be graft copolymerizable with the rubber polymer and may include, for example, styrene, α-methyl styrene, β-methyl styrene, p-methyl styrene, p-t-butyl styrene, ethyl styrene, vinylxylene, monochlorostyrene, dichlorostyrene, dibromostyrene, vinyl naphthalene, and the like. These may be used alone or as a mixture thereof. The aromatic vinyl monomer may be present in an amount of about 10 wt % to about 90 wt %, for example, about 10 wt % to about 60 wt %, based on 100 wt % of the monomer mixture. Within this range, the thermoplastic resin composition can have good properties in terms of processability, impact resistance, and the like.

In some embodiments, the vinyl cyanide monomer is a monomer copolymerizable with the aromatic vinyl monomer and may include, for example, acrylonitrile, methacrylonitrile, ethacrylonitrile, phenyl acrylonitrile, α-chloroacrylonitrile, and fumaronitrile, without being limited thereto. These may be used alone or as a mixture thereof. For example, the vinyl cyanide monomer may be acrylonitrile, methacrylonitrile, and the like. The vinyl cyanide monomer may be present in an amount of about 5 wt % to about 60 wt %, for example, about 10 wt % to about 50 wt %, based on 100 wt % of the monomer mixture. Within this range, the thermoplastic resin composition can have good properties in terms of chemical resistance, mechanical properties, and the like.

In some embodiments, the monomer for imparting processability and heat resistance may include, for example, (meth)acrylic acid, C₁ to C₁₀ alkyl (meth)acrylate, maleic anhydride, and N-substituted maleimide, without being limited thereto. The monomer for imparting processability and heat resistance may be present in an amount of about 60 wt % or less, for example, about 1 wt % to about 50 wt %, based on 100 wt % of the monomer mixture. Within this range, the monomer for imparting processability and heat resistance can impart processability and heat resistance to the thermoplastic resin composition without deterioration in other properties.

In some embodiments, the rubber-modified vinyl graft copolymer may include a copolymer (g-ABS) obtained by grafting a styrene monomer as the aromatic vinyl compound and an acrylonitrile monomer as the vinyl cyanide compound to a butadiene rubber polymer, a copolymer (g-MBS) obtained by grafting a styrene monomer as the aromatic vinyl compound and methyl methacrylate as the monomer for imparting processability and heat resistance to a butadiene rubber polymer, a copolymer (g-MABS) obtained by grafting a styrene monomer, an acrylonitrile monomer and methyl methacrylate to a butadiene rubber polymer, an acrylate-styrene-acrylonitrile graft copolymer (g-ASA) obtained by grafting a styrene monomer as the aromatic vinyl compound and an acrylonitrile monomer as the vinyl cyanide compound to a butyl acrylate rubber polymer, and the like.

In some embodiments, the rubber-modified vinyl graft copolymer may be present in an amount of about 20 wt % to about 50 wt %, for example, about 25 wt % to about 45 wt %, based on 100 wt % of the rubber-modified aromatic vinyl copolymer resin. Within this range, the thermoplastic resin composition can exhibit good properties in terms of impact resistance, fluidity (molding processability), appearance characteristics, balance therebetween, and the like.

(A2) Aromatic Vinyl Copolymer Resin

The aromatic vinyl copolymer resin according to one embodiment of the present invention may include an aromatic vinyl copolymer resin used in typical rubber-modified aromatic vinyl copolymer resins. For example, the aromatic vinyl copolymer resin may be a polymer of a monomer mixture including an aromatic vinyl monomer and a monomer copolymerizable with the aromatic vinyl monomer.

In some embodiments, the aromatic vinyl copolymer resin may be obtained by mixing the aromatic vinyl monomer with the monomer copolymerizable with the aromatic vinyl monomer, followed by polymerization of the mixture. Here, polymerization may be performed by any suitable polymerization method known in the art, such as emulsion polymerization, suspension polymerization, bulk polymerization, and the like.

In some embodiments, the aromatic vinyl monomer may include styrene, α-methyl styrene, β-methylstyrene, p-methyl styrene, p-t-butylstyrene, ethyl styrene, vinylxylene, monochlorostyrene, dichlorostyrene, dibromostyrene, and vinyl naphthalene, without being limited thereto. These may be used alone or as a mixture thereof. The aromatic vinyl monomer may be present in an amount of about 10 wt % to about 95 wt %, for example, about 20 wt % to about 90 wt %, based on 100 wt % of the aromatic vinyl copolymer resin. Within this range, the thermoplastic resin composition can have good properties in terms of impact resistance, fluidity, and the like.

In some embodiments, the monomer copolymerizable with the aromatic vinyl monomer may include a vinyl cyanide monomer and/or an alkyl (meth)acrylic monomer. For example, the monomer copolymerizable with the aromatic vinyl monomer may include a vinyl cyanide monomer or a vinyl cyanide monomer and an alkyl (meth)acrylic monomer, specifically a vinyl cyanide monomer and an alkyl (meth)acrylic monomer.

In some embodiments, the vinyl cyanide monomer may include acrylonitrile, methacrylonitrile, ethacrylonitrile, phenyl acrylonitrile, α-chloroacrylonitrile, and fumaronitrile, without being limited thereto. These may be used alone or as a mixture thereof. For example, the vinyl cyanide monomer may include acrylonitrile, methacrylonitrile, and the like.

In some embodiments, the alkyl (meth)acrylic monomer may include (meth)acrylic acid and/or C₁ to C₁₀ alkyl (meth)acrylates. These may be used alone or as a mixture thereof. For example, methyl methacrylate, methyl acrylate and the like may be used.

The monomer copolymerizable with the aromatic vinyl monomer may be present in an amount of about 5 wt % to about 90 wt %, for example, about 10 wt % to about 80 wt %, based on 100 wt % of the aromatic vinyl copolymer resin. Within this range, the thermoplastic resin composition can have good properties in terms of impact resistance, fluidity, and the like.

In some embodiments, the aromatic vinyl copolymer resin may have a weight average molecular weight (Mw) of about 10,000 g/mol to about 300,000 g/mol, for example, about 15,000 g/mol to about 150,000 g/mol, as measured by gel permeation chromatography (GPC). Within this range, the thermoplastic resin composition can have good mechanical strength, moldability, and the like.

In some embodiments, the aromatic vinyl copolymer resin may be present in an amount of about 50 wt % to about 90 wt %, for example, about 55 wt % to about 85 wt %, based on 100 wt % of the rubber-modified aromatic vinyl copolymer resin. Within this range, the thermoplastic resin composition can exhibit good properties in terms of impact resistance, fluidity (molding processability), and the like.

(B) Propylene-Ethylene Random Copolymer Resin

According to the present invention, the propylene-ethylene random copolymer resin serves to improve chemical resistance (oil resistance), moldability and the like of the thermoplastic resin composition and may be an amorphous or low crystalline propylene-ethylene random copolymer resin.

In some embodiments, the propylene-ethylene random copolymer resin may be a polymer of a monomer mixture including about 90 wt % to about 99 wt %, for example, about 94 to about 97 wt %, of propylene and about 1 wt % to about 10 wt %, for example, about 3 wt % to about 6 wt %, of ethylene. Within this range, the thermoplastic resin composition can exhibit good chemical resistance (oil resistance), good moldability, and the like.

In some embodiment, the propylene-ethylene random copolymer resin may have a melt-flow index (MI) of about 1 g/10 min to about 10 g/10 min, for example, about 1 g/10 min to about 5 g/10, as measured under conditions of 230° C. and 2.16 kgf in accordance with ASTM D1238. Within this range, the thermoplastic resin composition can exhibit good chemical resistance (oil resistance), good moldability, and the like.

In some embodiments, the propylene-ethylene random copolymer resin may be present in an amount of about 6 parts by weight to about 35 parts by weight, for example, about 10 parts by weight to about 30 parts by weight, relative to about 100 parts by weight of the rubber-modified aromatic vinyl copolymer resin. If the content of the propylene-ethylene random copolymer resin is less than about 6 parts by weight, the thermoplastic resin composition can suffer from deterioration in chemical resistance (oil resistance) and the like, and if the content of the propylene-ethylene random copolymer resin exceeds about 35 parts by weight, the thermoplastic resin composition can suffer from deterioration in compatibility, moldability, rigidity, and the like.

(C) Styrene-Butadiene Rubber Polymer

According to the present invention, the styrene-butadiene rubber polymer serves to improve compatibility of the rubber-modified aromatic vinyl copolymer resin and the propylene-ethylene random copolymer resin while improving impact resistance, rigidity and the like of thermoplastic resin composition together with the ethylene-α-olefin rubber polymer.

In some embodiments, the styrene-butadiene rubber polymer may be a polymer of a monomer mixture including about 25 wt % to about 45 wt %, for example, about 25 wt % to about 35 wt %, of styrene and about 55 wt % to about 75 wt %, for example, about 60 wt % to about 70 wt %, of butadiene. Within this range, the thermoplastic resin composition can exhibit good impact resistance and good rigidity.

In some embodiments, the styrene-butadiene rubber polymer may have a melt-flow index (MI) of about 1 g/10 min to about 10 g/10 min, for example, about 3 g/10 min to about 8 g/10 min, as measured under conditions of 200° C. and 5 kgf in accordance with ASTM D1238. Within this range, the thermoplastic resin composition can exhibit good impact resistance and good rigidity.

In some embodiments, the styrene-butadiene rubber polymer may be present in an amount of about 3 parts by weight to about 10 parts by weight, for example, about 4 parts by weight to about 7 parts by weight, relative to about 100 parts by weight of the rubber-modified aromatic vinyl copolymer resin. If the content of the styrene-butadiene rubber polymer is less than about 3 parts by weight, the thermoplastic resin composition can suffer from deterioration in impact resistance, rigidity, compatibility, and the like, and if the content of the styrene-butadiene rubber polymer exceeds, about 10 parts by weight, the thermoplastic resin composition can suffer from deterioration in rigidity and the like.

In some embodiments, the propylene-ethylene random copolymer resin (B) and the styrene-butadiene rubber polymer (C) may be present in a weight ratio (B:C) of about 2:1 to about 4:1, for example, about 2:1 to about 3:1. Within this range, the thermoplastic resin composition can exhibit good properties in terms of impact resistance, rigidity, compatibility, and the like.

(D) Ethylene-α-Olefin Rubber Polymer

According to the present invention, the ethylene-α-olefin rubber polymer serves to improve compatibility of the rubber-modified aromatic vinyl copolymer resin with the propylene-ethylene random copolymer resin while improving impact resistance, rigidity and the like of the thermoplastic resin composition together with the styrene-butadiene rubber polymer.

In some embodiments, the ethylene-α-olefin rubber polymer may be a polymer of a monomer mixture including about 25 wt % to about 55 wt %, for example, about 30 wt % to about 50 wt %, of ethylene and about 45 wt % to about 75 wt % of, for example, about 50 wt % to about 70 wt %, of α-olefin. Within this range, the thermoplastic resin composition can exhibit good impact resistance and good rigidity.

In some embodiments, the ethylene-α-olefin rubber polymer may include at least one of ethylene-1-octene copolymer, ethylene-1-butene copolymer, ethylene-1-pentene copolymer, ethylene-1-hexene copolymer, ethylene-1-heptene copolymer, ethylene-1-decene copolymer, ethylene-1-undecene copolymer, and ethylene-1-dodecene copolymer.

In some embodiments, the ethylene-α-olefin rubber polymer may have a specific gravity of about 0.85 to about 0.88, for example, about 0.86 to about 0.87, as measured in accordance with ASTM D792, and a melt-flow index (MI) of about 0.5 g/10 min to about 5 g/10 min, for example, about 0.5 g/10 min to about 2 g/10 min, as measured under conditions of 190° C. and 2.16 kgf in accordance with ASTM D1238. Within this range, the thermoplastic resin composition can exhibit good impact resistance and good rigidity.

In some embodiments, the ethylene-α-olefin rubber polymer may be present in an amount of about 1 part by weight to about 10 parts by weight, for example, about 2 parts by weight to about 8 parts by weight, relative to about 100 parts by weight of the rubber-modified aromatic vinyl copolymer resin. If the content of the ethylene-α-olefin rubber polymer is less than about 2 parts by weight, the thermoplastic resin composition can suffer from deterioration in impact resistance and the like, and if the content of the ethylene-α-olefin rubber polymer exceeds about 10 parts by weight, the thermoplastic resin composition can suffer from deterioration in rigidity, heat resistance, and the like.

In some embodiments, the styrene-butadiene rubber polymer (C) and the ethylene-α-olefin rubber polymer (D) may be present in a weight ratio (C:D) of about 1:1 to about 3:1, for example, about 1.5:1 to about 2:1. Within this range, the thermoplastic resin composition can exhibit good impact resistance and good rigidity.

According to one embodiment of the invention, the thermoplastic resin composition may further include additives used for typical thermoplastic resin compositions. Examples of the additives may include inorganic fillers, flame retardants, anti-dripping agents, antioxidants, lubricants, release agents, nucleating agents, stabilizers, pigments, dyes, and mixtures thereof, without being limited thereto. The additives may be present in an amount of about 0.001 parts by weight to about 40 parts by weight, for example, about 0.1 parts by weight to about 10 parts by weight, relative to about 100 parts by weight of the rubber-modified aromatic vinyl copolymer resin.

The thermoplastic resin composition according to one embodiment of the present invention may be prepared in pellet form by mixing the aforementioned components, followed by melt extrusion at about 180° C. to about 260° C., for example, about 200° C. to about 250° C., using a typical twin-screw extruder.

In some embodiments, the thermoplastic resin composition may have a dispersion of the rubber-modified aromatic vinyl copolymer resin and the ethylene-α-olefin rubber polymer present in a continuous phase of the propylene-ethylene random copolymer resin, in which the styrene-butadiene rubber polymer may be present at an interface between the propylene-ethylene random copolymer resin and the rubber-modified aromatic vinyl copolymer resin.

In some embodiments, the thermoplastic resin composition may have a notched Izod impact strength of about 13 kgf·cm/cm to about 25 kgf·cm/cm, for example, about 13 kgf·cm/cm to about 20 kgf·cm/cm, as measured on a ¼″ thick specimen in accordance with ASTM D256.

In some embodiments, the thermoplastic resin composition may have a tensile strength of about 250 kgf/cm² to about 400 kgf/cm², for example, about 250 kgf/cm² to about 350 kgf/cm², as measured on a 3.2 mm thick specimen at 5 mm/min in accordance with ASTM D638.

In some embodiments, the thermoplastic resin composition may have a Vicat softening temperature of about 80° C. to about 95° C., for example, about 85° C. to about 95° C., as measured under a load of 5 kgf at 50° C./hr in accordance with ISO R306.

In some embodiments, the thermoplastic resin composition may have a crack generation strain (ε) of about 1% to about 1.2%, for example, about 1.04% to about 1.16%, as calculated on a specimen having a size of 200 mm×50 mm×2 mm according to Equation 1 after the specimen is mounted on a ¼ elliptical jig (major axis length: 120 mm, minor axis length: 34 mm), entirely coated with 10 ml of olive oil, and left for 24 hours.

$$ε = \frac{{b}^{2}}{2 \times {a}^{2}} \times {\{ 1 - \frac{( {a}^{2} - {b}^{2} )}{{a}^{4}} \times {x}^{2} \}}^{- 3 / 2} \times t \times 100 \qquad [ Equation 1 ]$$

where ε denotes crack generation strain, a denotes the major axis length (mm) of the elliptical jig, b denotes the minor axis length (mm) of the elliptical jig, t denotes the thickness (mm) of the specimen, and x denotes a distance from an vertical intersection point between a point at which cracking occurs and the major axis of the elliptical jig to a central point of the elliptical jig.

In some embodiments, the thermoplastic resin composition may have a high temperature tensile strength of about 10 kgf/cm² to about 20 kgf/cm², for example, about 10 kgf/cm² to about 15 kgf/cm², as measured on a specimen having a size of 65 mm×3.2 mm (length×thickness) at 150 mm/min in accordance with ASTM D638 after aging the specimen in a chamber at 130° C. for 5 min.

A molded article according to the present invention is produced from the thermoplastic resin composition set forth above. The thermoplastic resin composition may be prepared in pellet form. The prepared pellets may be produced into various molded articles (products) by various molding methods, such as injection molding, extrusion molding, vacuum molding, and casting. These molding methods are well known to those skilled in the art. The molded articles may be produced by vacuum molding and have good properties in terms of impact resistance, rigidity, heat resistance, chemical resistance (oil resistance), moldability, and balance therebetween to be usefully used for interior and exterior materials for refrigerators.

In some embodiments, the molded article may be a material inside a refrigerator in contact with an expanded layer which may be expanded with HFO (hydrofluoroolefin) or Freon.

### MODE FOR INVENTION

Next, the present invention will be described in more detail with reference to some examples. It should be understood that these examples are provided for illustration only and are not to be construed in any way as limiting the invention.

### EXAMPLE

Details of components used in Examples and Comparative Examples are as follows.

(A) Rubber-Modified Aromatic Vinyl Copolymer Resin

A mixture of 25 wt % of (A1) a rubber-modified vinyl graft copolymer and 75 wt % of (A2) an aromatic vinyl copolymer resin was used.

(A1) Rubber-Modified Vinyl Graft Copolymer

g-ABS prepared by graft copolymerization of styrene and acrylonitrile (weight ratio: 75/25) to 55 wt % of butadiene rubbers having an average particle size of 0.3 μm was used.

(A2) Aromatic Vinyl Copolymer Resin

A SAN resin (weight average molecular weight: 140,000 g/mol) prepared by polymerization of 80 wt % of styrene and 20 wt % of acrylonitrile was used.

(B1) An ethylene-propylene random copolymer rein (Manufacturer: Lotte Chemical Co., Ltd., Product Name: SB-520, melt-flow index 1.8 g/10 min) was used.

(B2) A polypropylene resin (Manufacturer: Lotte Chemical Co., Ltd., Product Name: H1500) was used.

(B3) An ethylene-propylene block copolymer rein (Manufacturer: Lotte Chemical Co., Ltd., Product Name: JH-370A) was used.

(C1) Styrene-butadiene rubber polymer (SBR, Manufacturer: Kumho Petrochemical Co., Ltd., Product Name: KTR-201, styrene content: 31.5 wt %) was used.

(C2) Styrene-ethylene-butadiene-styrene copolymer (SEB S, Manufacturer: KRATON, Product Name: G1652) was used.

(D1) As an ethylene-α-olefin rubber polymer, an ethylene-1-octene rubber polymer (EOR, Manufacturer: DOW, Product Name: ENGAGE8150) was used.

(D2) Maleic anhydride-grafted ethylene-octene rubber (EOR-g-MA, Manufacturer: Useung Chemical Co., Ltd., Product Name: SP2000S) was used.

### Examples 1 to 7 and Comparative Examples 1 to 10

The above components were mixed in amounts as listed in Tables 1, 2 and 3, and subjected to extrusion at 200° C., thereby preparing pellets. Here, extrusion was performed using a twin-screw extruder (L/D=36, Φ: 45 mm) and the prepared pellets were dried at 80° C. for 4 hours or more and injection-molded in a 6 oz. injection molding machine (molding temperature: 230° C., mold temperature: 60° C.), thereby preparing specimens. The specimens were evaluated as to the following properties by the following method, and results are shown in Tables 1, 2 and 3.

Property Measurement

(1) Notched Izod impact strength (kgf·cm/cm): Notched Izod impact strength was measured on a ¼″ thick specimen in accordance with ASTM D256.

(2) Tensile strength (TS, unit: kgf/cm²): Tensile strength was measured on a 3.2 mm thick specimen at 5 mm/min in accordance with ASTM D638.

(3) Vicat Softening Temperature (VST, unit: ° C.): Vicat Softening Temperature was measured under a load of 5 kgf at 50° C./hr in accordance with ISO R306.

(4) Crack generation strain (c, unit: %): Crack generation strain was calculated on a specimen having a size of 200 mm×50 mm×2 mm according to Equation 1 after the specimen was mounted on a ¼ elliptical jig (major axis length: 120 mm, minor axis length: 34 mm), entirely coated with 10 ml of olive oil, and left for 24 hours.

$$ε = \frac{{b}^{2}}{2 \times {a}^{2}} \times {\{ 1 - \frac{( {a}^{2} - {b}^{2} )}{{a}^{4}} \times {x}^{2} \}}^{- 3 / 2} \times t \times 100 \qquad [ Equation 1 ]$$

where ε denotes crack generation strain, a denotes the major axis length (mm) of the elliptical jig, b denotes the minor axis length (mm) of the elliptical jig, t denotes the thickness (mm) of the specimen, and x denotes a distance from a vertical intersection point between a point at which cracking occurs and the major axis of the elliptical jig to a central point of the elliptical jig.

(5) High temperature tensile strength (unit: kgf/cm²): High temperature tensile strength was measured on a specimen having a size of 65 mm×3.2 mm (length×thickness) at 150 mm/min in accordance with ASTM D638 after aging the specimen in a chamber at 130° C. for 5 min.

TABLE 1

| | Example | | | | | | |
|---|---|---|---|---|---|---|---|
| | 1 | 2 | 3 | 4 | 5 | 6 | 7 |
| (A) (parts by weight) | 100 | 100 | 100 | 100 | 100 | 100 | 100 |
| (B1) (parts by weight) | 10 | 15 | 30 | 15 | 15 | 15 | 15 |
| (B2) (parts by weight) | — | — | — | — | — | — | — |
| (B3) (parts by weight) | — | — | — | — | — | — | — |
| (Cl) (parts by weight) | 5 | 5 | 5 | 3 | 10 | 5 | 5 |
| (C2) (parts by weight) | — | — | — | — | — | — | — |
| (D1) (parts by weight) | 3 | 3 | 3 | 3 | 3 | 1 | 10 |
| (D2) (parts by weight) | — | — | — | — | — | — | — |
| Notched Izod impact strength | 19 | 18 | 15 | 14 | 22 | 13 | 22 |
| Tensile strength | 330 | 320 | 290 | 250 | 270 | 330 | 250 |
| Vicat softening temperature | 90 | 88 | 85 | 93 | 85 | 94 | 85 |
| Crack generation strain (ε) | 1.04 | 1.14 | 1.16 | 1.08 | 1.14 | 1.14 | 1.14 |
| High temperature tensile | 12 | 13 | 14 | 13 | 11 | 11 | 10 |
| strength | | | | | | | |

TABLE 2

| | Comparative Example | | | | |
|---|---|---|---|---|---|
| | 1 | 2 | 3 | 4 | 5 |
| (A) (parts by weight) | 100 | 100 | 100 | 100 | 100 |
| (B1) (parts by weight) | — | — | 5 | 40 | 15 |
| (B2) (parts by weight) | 15 | — | — | — | — |
| (B3) (parts by weight) | — | 15 | — | — | — |
| (C1) (parts by weight) | 5 | 5 | 5 | 5 | — |
| (C2) (parts by weight) | — | — | — | — | 5 |
| (D1) (parts by weight) | 3 | 3 | 3 | 3 | 3 |
| (D2) (parts by weight) | — | — | — | — | — |
| Notched Izod impact | 11 | 18 | 20 | 13 | 10 |
| strength | | | | | |
| Tensile strength | 320 | 300 | 330 | 240 | 320 |
| Vicat softening | 89 | 86 | 90 | 77 | 88 |
| temperature | | | | | |
| Crack generation strain | 1.10 | 1.08 | 0.98 | 1.16 | 1.14 |
| (ε) | | | | | |
| High temperature tensile | 8 | 4 | 11 | 6 | 10 |
| strength | | | | | |

TABLE 3

| | Comparative Example | | | | |
|---|---|---|---|---|---|
| | 6 | 7 | 8 | 9 | 10 |
| (A) (parts by weight) | 100 | 100 | 100 | 100 | 100 |
| (B1) (parts by weight) | 15 | 15 | 15 | 15 | 15 |
| (B2) (parts by weight) | — | — | — | — | — |
| (B3) (parts by weight) | — | — | — | — | — |
| (C1) (parts by weight) | 2 | 12 | 5 | 5 | 5 |
| (C2) (parts by weight) | — | — | — | — | — |
| (D1) (parts by weight) | 3 | 3 | — | 0.5 | 12 |
| (D2) (parts by weight) | — | — | 3 | — | — |
| Notched Izod impact | 8 | 19 | 11 | 11 | 20 |
| strength | | | | | |
| Tensile strength | 260 | 240 | 300 | 330 | 230 |
| Vicat softening | 93 | 79 | 88 | 94 | 78 |
| temperature | | | | | |
| Crack generation strain | 1.08 | 1.12 | 1.08 | 1.12 | 1.14 |
| (ε) | | | | | |
| High temperature tensile | 10 | 10 | 11 | 11 | 10 |
| strength | | | | | |

From the above results, it could be seen that the thermoplastic resin compositions according to the present invention exhibited good properties in terms of impact resistance (Notched Izod impact strength), rigidity (tensile strength), heat resistance (Vicat softening temperature), chemical resistance (crack generation strain), moldability (high temperature tensile strength), and the like.

Conversely, it could be seen that, as prepared in Comparative Example 1, wherein the polypropylene resin (B2) was used instead of the ethylene-propylene random copolymer rein (B1), the thermoplastic resin composition suffered from deterioration in impact resistance, moldability, and the like; as prepared in Comparative Example 2, wherein the ethylene-propylene block copolymer rein (B3) was used instead of the ethylene-propylene random copolymer rein (B1), the thermoplastic resin composition suffered from deterioration in moldability and the like; as prepared in Comparative Example 3, wherein the content of the ethylene-propylene random copolymer rein was insufficient, the thermoplastic resin composition suffered from deterioration in chemical resistance and the like; and, as prepared in Comparative Example 4, wherein the content of the ethylene-propylene random copolymer rein was excessive, the thermoplastic resin composition suffered from deterioration in heat resistance, rigidity, and the like. It could be seen that, as prepared in Comparative Example 5, wherein the styrene-ethylene-butadiene-styrene copolymer (C2) was used instead of the styrene-butadiene rubber polymer (C1), the thermoplastic resin composition suffered from deterioration in impact resistance, compatibility, and the like; as prepared in Comparative Example 6, wherein the content of the styrene-butadiene rubber polymer was insufficient, the thermoplastic resin composition suffered from deterioration in impact resistance, compatibility, and the like; and as prepared in Comparative Example 7, wherein the content of the styrene-butadiene rubber polymer was excessive, the thermoplastic resin composition suffered from deterioration in heat resistance, rigidity, and the like. In addition, it could be seen that, as prepared in Comparative Example 8 wherein the maleic anhydride-grafted ethylene-octene rubber (D2) was used instead of the ethylene-1-octene rubber polymer (D1), the thermoplastic resin composition suffered from deterioration in impact resistance and the like; as prepared in Comparative Example 9 wherein the ethylene-1-octene rubber polymer was insufficient, the thermoplastic resin composition the thermoplastic resin composition suffered from deterioration in impact resistance and the like; and, as prepared in Comparative Example 10 wherein the ethylene-1-octene rubber polymer was excessive, the thermoplastic resin composition suffered from deterioration in heat resistance, rigidity, and the like.

It should be understood that various modifications, changes, alterations, and equivalent embodiments can be made by those skilled in the art without departing from the spirit and scope of the present invention.

1. A thermoplastic resin composition comprising:
about 100 parts by weight of a rubber-modified aromatic vinyl copolymer resin;
about 6 parts by weight to about 35 parts by weight of a propylene-ethylene random copolymer resin;
about 3 parts by weight to about 10 parts by weight of a styrene-butadiene rubber polymer; and
about 1 part by weight to about 10 parts by weight of an ethylene-α-olefin rubber polymer.

2. The thermoplastic resin composition according to claim 1, wherein the rubber-modified aromatic vinyl copolymer resin comprises a rubber-modified vinyl graft copolymer and an aromatic vinyl copolymer resin.

3. The thermoplastic resin composition according to claim 2, wherein the rubber-modified vinyl graft copolymer is prepared through graft polymerization of a monomer mixture comprising an aromatic vinyl monomer and a vinyl cyanide monomer to a rubber polymer.

4. The thermoplastic resin composition according to claim 1, wherein the propylene-ethylene random copolymer resin is a polymer of a monomer mixture comprising about 90 wt % to about 99 wt % of propylene and about 1 wt % to about 10 wt % of ethylene.

5. The thermoplastic resin composition according to claim 1, wherein the propylene-ethylene random copolymer resin has a melt-flow index (MI) of about 1 g/10 min to about 10 g/10 min, as measured under conditions of 230° C. and 2.16 kgf in accordance with ASTM D1238.

6. The thermoplastic resin composition according to claim 1, wherein the styrene-butadiene rubber polymer is a polymer of a monomer mixture comprising about 25 wt % to about 45 wt % of styrene and about 55 wt % to about 75 wt % of butadiene.

7. The thermoplastic resin composition according to claim 1, wherein the ethylene-α-olefin rubber polymer is a polymer of a monomer mixture comprising about 25 wt % to about 55 wt % of ethylene and about 45 wt % to about 75 wt % of α-olefin.

8. The thermoplastic resin composition according to claim 1, wherein the propylene-ethylene random copolymer resin and the styrene-butadiene rubber polymer are present in a weight ratio of about 2:1 to about 4:1.

9. The thermoplastic resin composition according to claim 1, wherein the styrene-butadiene rubber polymer and the ethylene-α-olefin rubber polymer are present in a weight ratio of about 1:1 to about 3:1.

10. The thermoplastic resin composition according to claim 1, wherein the thermoplastic resin composition has a notched Izod impact strength of about 13 kgf·cm/cm to about 25 kgf·cm/cm, as measured on a ¼″ thick specimen in accordance with ASTM D256.

11. The thermoplastic resin composition according to claim 1, wherein the thermoplastic resin composition has a tensile strength of about 250 kgf/cm² to about 400 kgf/cm², as measured on a 3.2 mm thick specimen at 5 mm/min in accordance with ASTM D638.

12. The thermoplastic resin composition according to claim 1, wherein the thermoplastic resin composition has a Vicat softening temperature of about 80° C. to about 95° C., as measured under a load of 5 kgf at 50° C./hr in accordance with ISO R306.

13. The thermoplastic resin composition according to claim 1, wherein the thermoplastic resin composition has a crack generation strain (ε) of about 1% to about 1.2%, as calculated on a specimen having a size of 200 mm×50 mm×2 mm according to Equation 1 after the specimen is mounted on a ¼ elliptical jig (major axis length: 120 mm, minor axis length: 34 mm), entirely coated with 10 ml of olive oil, and left for 24 hours:
$$ε = \frac{{b}^{2}}{2 \times {a}^{2}} \times {\{ 1 - \frac{( {a}^{2} - {b}^{2} )}{{a}^{4}} \times {x}^{2} \}}^{- 3 / 2} \times t \times 100 \qquad [ Equation 1 ]$$
where ε denotes crack generation strain, a denotes the major axis length (mm) of the elliptical jig, b denotes the minor axis length (mm) of the elliptical jig, t denotes the thickness (mm) of the specimen, and x denotes a distance from an vertical intersection point between a point at which cracking occurs and the major axis of the elliptical jig to a central point of the elliptical jig.

14. The thermoplastic resin composition according to claim 1, wherein the thermoplastic resin composition has a high temperature tensile strength of about 10 kgf/cm² to about 20 kgf/cm², as measured on a specimen having a size of 65 mm×3.2 mm (length×thickness) at 150 mm/min in accordance with ASTM D638 after aging the specimen in a chamber at 130° C. for 5 min.

15. A molded article produced from the thermoplastic resin composition according to claim 1.
